(19) United States
(12) Patent Application Publication
(10) Pub. No.: US 2022/0144560 A1
(43) Pub. Date: May 12, 2022

(54) OIL SEAL DISTRIBUTING MECHANISM FOR VIBRATOR BOWL

(71) Applicant: ZHEJIANG LINIX MOTOR CO., LTD., DONGYANG, Zhejiang Province (CN)

(72) Inventors: HUI WANG, DONGYANG, ZHEJIANG PROVINCE (CN); HAO QIAN, DONGYANG, ZHEJIANG PROVINCE (CN); JIANHUA JI, HANGZHOU, ZHEJIANG PROVINCE (CN)

(21) Appl. No.: 17/433,596

(22) PCT Filed: Apr. 27, 2020
(86) PCT No.: PCT/CN2020/087190

§ 371 Date: Aug. 24, 2021

(30) Foreign Application Priority Data
Nov. 11, 2019 (CN) 201911097295.8

(51) Int. Cl. B65G 47/14; B65G 47/256

(52) U.S. Cl. CPC B65G 47/1421; B65G 2201/047; B65G 47/256

(57) ABSTRACT

An object of the present invention is to provide an oil seal distributing mechanism for a vibrator bowl, which is structured as follows. A feeding track of the vibrator bowl comprises a left side plate and a base plate, a through groove running vertically and taking a right side wall of the left side plate as its left side wall is provided at a portion of the base plate close to the left side plate, and a distributor, having a minimum distance L between its leftmost edge and the right side wall of the left side plate, is provided in the through groove; an oil seal has an outer diameter D, a maximum inner diameter d1 and a minimum inner diameter d2, where L>D-d1; a distance between front and rear walls of the through groove is greater than the outer diameter of the oil seal; the base plate is aslant arranged and/or a force applying mechanism is provided above the through groove, and the base plate gradually extends upward from left to right when the base plate is aslant arranged; and the force applying mechanism is configured to enable an edge of the oil seal close to the left side plate to flip down.

### TECHNICAL FIELD OF THE INVENTION

The present invention relates to an oil seal distributing mechanism for a vibrator bowl or disk.

### BACKGROUND TECHNOLOGY

In the prior art, oil seals are often conveyed in an orderly and directional arrangement through a vibrator bowl or disk, but existing vibrator bowls are incapable of determining the front and back of oil seals or distributing oil seals.

### SUMMARY OF THE INVENTION

An object of the present invention is to provide an oil seal distributing mechanism for a vibrator bowl, which can distribute oil seals.

To achieve the above object, a technical solution employed in the present invention is as follows. An oil seal distributing mechanism for a vibrator bowl is provided. A feeding track of the vibrator bowl includes a left side plate and a base plate, a through groove running vertically and taking a right side wall of the left side plate as its left side wall is provided at a portion of the base plate close to the left side plate, and a distributor, having a minimum distance L between its leftmost edge and the right side wall of the left side plate, is provided in the through groove. An oil seal has an outer diameter D, a maximum inner diameter is d1 and a minimum inner diameter is d2, where L>D-d1; a distance between front and rear walls of the through groove is greater than the outer diameter of the oil seal. The base plate is aslant arranged and/or a force applying mechanism is provided above the through groove, and the base plate gradually extends upward from left to right when the base plate is aslant arranged; and the force applying mechanism is configured to enable an edge of the oil seal close to the left side plate to flip down.

In use of the mechanism of the present invention, the oil seal moves forward along the feeding track. If the oil seal faces up when passing by a notch, the oil seal will be supported above a left edge of the distributor because of its minimum inner diameter, and thus will not drop down. If the oil seal faces down, that is, one side with a ring groove of the oil seal faces up, the oil seal will be suspended at its maximum inner diameter and will flip down to drop down under the action of force applying mechanism or gravity to realize the oil seal distribution because of the minimum distance L between the left edge of the distributor and the right side wall of the left side plate and the distance D-d1 between a circumferential outer wall of the oil seal and the maximum inner diameter. The force applying mechanism can enable the oil seal to drop down by blowing downward, flowing down or even by pressing down. When the base plate is aslant arranged, the oil seal will be closer to the left side plate and attached to the right side plate of the left side plate under the action of gravity, so that the oil seal can drop into the through groove is more easily. The distributor and the base plate may be two parts independent of each other, and the distributor may also be integrated with the base plate.

Preferably, the force applying mechanism includes air supply equipment and an air pipe. A force enabling the edge of the oil seal to flip down is applied by blowing to improve the distribution effect.

Preferably, the distributor is provided with a plurality of pivot ends each facing the left side plate and having a minimum distance L between its tip and the right side wall of the left side plate. Since an inner hole of the oil seal is round, the thinner the end of the distributor the better the distribution effect.

Preferably, a fixed tube, which is vertically arranged above the through groove and fixed to a bracket, is communicated with an end of the air pipe. The fixed tube will not wobble, so that an air outlet point of the force applying mechanism is more stable, and the oil seal distribution effect is better.

Preferably, a fixed plate on which a fixed hole fitted to a fixing bolt is formed is provided on an upper side or a lower side of the base plate, and the distributor is provided with a strip groove in the left and right direction and fixed to the fixed plate by the fixing bolt. The distributor can move left and right to adjust the distance between the left edge of the distributor and the right side wall of the left side plate, so as to distribute and feed oil seals of different types.

Preferably, a notch communicated with the through groove is provided on a hopper of the vibrator bowl. The above structure can feed oil seals more easily and guide the distributed oil seals into the hopper without efforts of workers, so as to reduce the labor intensity of workers.

The present invention has the advantages of distributing oil seals of different types and reducing labor intensity of workers.

### BRIEF DESCRIPTION OF THE DRAWINGS

FIG. 1 is a structural diagram according to the present invention;

FIG. 2 is a structural diagram of an oil seal that faces up when passing by a through groove according to the present invention;

FIG. 3 is a structural diagram of the oil seal that faces down when passing by the through groove according to the present invention; and

FIG. 4 is another structural diagram of the oil seal that faces down when passing by the through groove according to the present invention.

### DETAILED DESCRIPTION OF THE INVENTION

The present invention will be further described below with reference to accompanying drawings by embodiments.

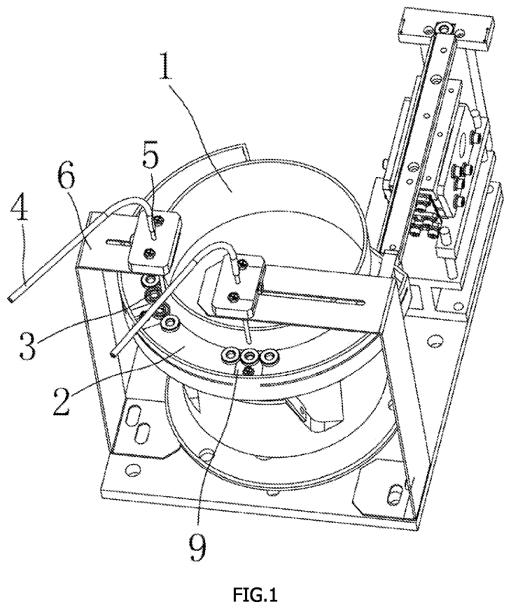

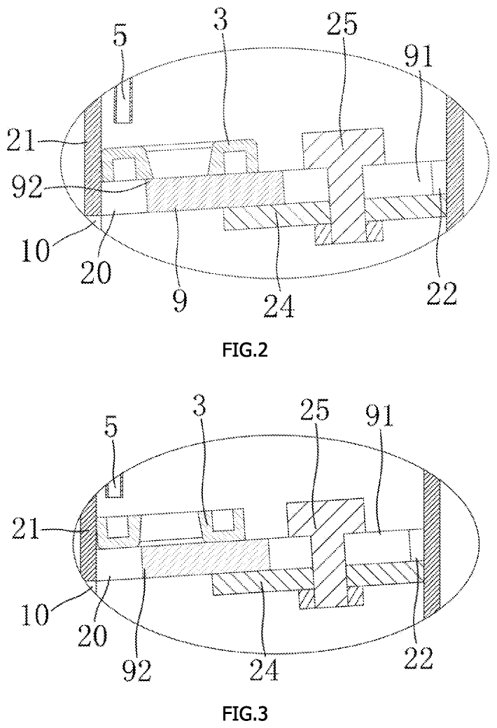

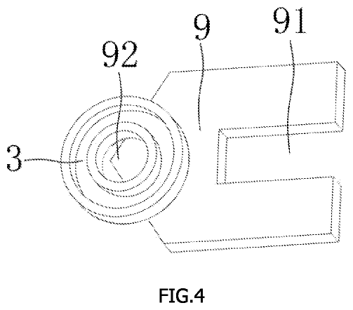

As shown in FIGS. 1 to 4, an oil seal distributing mechanism for a vibrator bowl is provided in the present invention. A feeding track 2 of the vibrator bowl/disk 1 includes a left side plate 21 and a base plate 22, a through groove 20 running vertically and taking a right side wall of the left side plate 21 as the through groove's left side wall is provided at a portion of the base plate 22 close to the left side plate 21, and a distributor 9, having a minimum distance L between its leftmost edge and the right side wall of the left side plate 21, is provided in the through groove 20. An oil seal 3 has an outer diameter D, a maximum inner diameter d1 and a minimum inner diameter d2, where L>D-d1. A distance between front and rear walls at a left end of the through groove 20 is greater than the outer diameter of the oil seal 3. The base plate 22 is aslant arranged. A force applying mechanism, which is configured to enable an edge of the oil seal 3 close to the left side plate 21 to flip down, is provided above the through groove 20, and the base plate 22 gradually extends upward from left to right. A notch 10 communicated with the through groove 20 is provided on a hopper of the vibrator bowl 1.

The force applying mechanism includes air supply equipment and an air pipe 4, and a fixed tube 5, which is vertically arranged above the through groove 20 and fixed to a is bracket 6, is communicated with an end of the air pipe 4.

The distributor 9 is provided with a plurality of pivot ends 92 each facing the left side plate and having a minimum distance L between its tip and the right side wall of the left side plate 21. A fixed plate 24 on which a fixed hole fitted to a fixing bolt 25 is formed is provided on a lower side of the base plate 22, and the distributor 9 is provided with a strip groove 91 in the left and right direction and fixed to the fixed plate 24 by the fixing bolt 25.

The present invention has the advantages of distributing oil seals of different types and reducing labor intensity of workers.

1. An oil seal distributing mechanism for a vibrator bowl, wherein a feeding track of the vibrator bowl comprises a left side plate and a base plate, a through groove running vertically and taking a right side wall of the left side plate as the through groove's left side wall is provided at a portion of the base plate close to the left side plate, and a distributor, having a minimum distance L between its leftmost edge and the right side wall of the left side plate, is provided in the through groove; an oil seal has an outer diameter D, a maximum inner diameter d1 and a minimum inner diameter d2, where L>D-d1; a distance between front and rear walls of the through groove is greater than the outer diameter of the oil seal; the base plate is aslant arranged and/or a force applying mechanism is provided above the through groove, and the base plate gradually extends upward from left to right when the base plate is aslant arranged; and the force applying mechanism is configured to enable an edge of the oil seal close to the left side plate to flip downward.

2. The oil seal distributing mechanism for the vibrator bowl according to claim 1, wherein the force applying mechanism comprises air supply equipment and an air pipe.

3. The oil seal distributing mechanism for the vibrator bowl according to claim 1, wherein the distributor is provided with a plurality of pivot ends each facing the left side plate and having a minimum distance L between pivot end's tip and the right side wall of the left side plate.

4. The oil seal distributing mechanism for the vibrator bowl according to claim 2, wherein a fixed tube, which is vertically arranged above the through groove and fixed to a bracket, is communicated with an end of the air pipe.

5. The oil seal distributing mechanism for the vibrator bowl according to claim 1, wherein a fixed plate on which a fixed hole fitted to a fixing bolt is formed is provided on an upper side or a lower side of the base plate, and the distributor is provided with a strip groove in the left and right direction and fixed to the fixed plate by the fixing bolt.

6. The oil seal distributing mechanism for the vibrator bowl according to claim 1, wherein a notch communicated with the through groove is provided on a hopper of the vibrator bowl.

7. The oil seal distributing mechanism for the vibrator bowl according to claim 3, wherein a fixed plate on which a fixed hole fitted to a fixing bolt is formed is provided on an upper side or a lower side of the base plate, and the distributor is provided with a strip groove in the left and right direction and fixed to the fixed plate by the fixing bolt.
